(19) United States
(12) Patent Application Publication
(10) Pub. No.: US 2007/0118683 A1
(43) Pub. Date: May 24, 2007

(54) Apparatus for updating television firmware and method therefor

(76) Inventors: Tsung-Hsien Yang, Taipei (TW); Sheng-Min Hsu, Taipei (TW); Yu-Lin Lo, Taoyuan Shien (TW); Juei-Long Lee, Yungho City (TW)

Correspondence Address: RABIN & Berdo, PC, 1101 14TH STREET, NW, SUITE 500, WASHINGTON, DC, 20005, US

(21) Appl. No.: 11/431,507

(22) Filed: May 11, 2006

(30) Foreign Application Priority Data
Nov. 4, 2005 (TW) 94138852

(51) Int. Cl. G06F 12/00

(52) U.S. Cl. 711/103

(57) ABSTRACT

An apparatus for updating a television firmware and the method therefor are provided. The television includes a first processor and a first memory unit. The first memory unit is for storing a television firmware. The television firmware updating apparatus includes a second memory unit and a second processor. The second memory unit stores an updating firmware. After the second processor handshakes with the first processor, the second processor reads and encodes a chosen block data of the updating firmware to output an encoded signal. The first processor decodes the encoded signal to generate a chosen block data and write the chosen block data to the first memory unit until all the block data of the updating firmware are written to the first memory unit.

This application claims the benefit of Taiwan application Serial No. 94138852, filed Nov. 4, 2005, the subject matter of which is incorporated herein by reference.

### BACKGROUND OF THE INVENTION

1. Field of the Invention

The invention relates in general to an apparatus capable of updating firmware and the method therefor, and more particularly to an apparatus for updating television firmware and the method therefor.

2. Description of the Related Art

Nowadays, television has become a popular electronic appliance. Atypical television includes a display device, a control circuit board, a power converter and other components. In a television set, firmware plays a very important role in operating the control IC of the control circuit board for enabling the television to display live programs or perform interactive functions. The firmware also responds to a remote controller held by a viewer. For example, the firmware provides on screen display (OSD) function for the viewer to adjust the frame, the sound and other settings. The firmware is normally stored in a flash memory and includes several programming codes. When the firmware is able to control other hardware via a micro-controller for enabling the television to display a complete frame. If error occurs to the firmware, the television is unable to perform the above functions and needs to be updated.

Referring to FIG. 1, a diagram illustrating the components for conventional firmware updating is shown. When the computer 110 updates the firmware of the television 130, the components involved include the computer 110, a conversion circuit board 120, an RS-232 transmission line 140, a VGA transmission line 150, a power supply of the conversion circuit board and a terminal program (stored in the computer 110).

Since the RS-232 port of the computer 110 is unable to handshake with the VGA port of the television 130, the conversion circuit board 120 connects the RS-232 port of the computer 110 to the VGA port of the television 130 via the RS-232 transmission line 140 and the VGA transmission line 150 for enabling the computer 110 to be electrically connected to the television 130. The updating of the firmware is executed through the terminal program. When the computer 110 executes the terminal program, several parameters such as the port number, the baud rate and the flow control need to be determined and a suitable firmware needs to be selected so that the updating of the firmware is completed.

The updating of a television firmware involves several actions, and it is indeed not easy to update a television firmware by a computer. Several parameters need to be determined before the updating of the television firmware is executed. The updating may fail if any error occurs during the updating process. Under such circumstance, the casing of the television needs to be dismounted for replacing the original memory with a memory having a new firmware to be disposed on the circuit board of the television. Consequently, a large amount of time and labor are wasted.

### SUMMARY OF THE INVENTION

It is therefore an object of the invention to provide an apparatus for updating a television firmware and a method therefor. By means of the television firmware updating apparatus, human interferences are avoided when updating a firmware, hence reducing the error rate as well as the labor and costs involved.

The invention achieves the above-identified object by providing a television firmware updating apparatus used for updating a television firmware. The television includes a first processor and a first memory unit. The first memory unit is for storing a television firmware. The television firmware updating apparatus includes a second memory unit and a second processor. The second memory unit stores an updating firmware. After the second processor handshakes with the first processor, the second processor reads and encodes a chosen block data of the updating firmware to output an encoded signal. The first processor decodes the encoded signal to generate the chosen block data and write the chosen block data to the first memory unit until all the block data of the updating firmware are written to the first memory unit.

The invention further achieves the above-identified object by providing a television firmware updating method applied in an apparatus for updating television firmware. The television firmware updating apparatus stores an updating firmware. Firstly, the television firmware updating apparatus handshakes with a television. The television includes a first processor and a first memory unit. The first memory unit is for storing a television firmware. Next, a chosen block data of the updating firmware is read and encoded to generate an encoded signal. Then, the encoded signal is transmitted to the first processor of the television. Afterwards, the first processor decodes the encoded signal to generate the chosen block data and write the chosen block data to the first memory unit. Lastly, the step of generating and transmitting an encoded signal is repeated until all the block data of the updating firmware are written to the first memory unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates the components for conventional firmware updating;

FIG. 2 illustrates a television firmware updating apparatus according to a preferred embodiment of the invention being linked to a television;

FIG. 3 illustrates a block diagram of the television firmware updating apparatus according to the preferred embodiment of the invention and the television;

FIG. 4 illustrates a flowchart of a television firmware updating method according to a preferred embodiment of the invention; and

FIG. 5 illustrates a flowchart of a method for decoding an encoded signal to generate a chosen block data and writing the chosen block data.

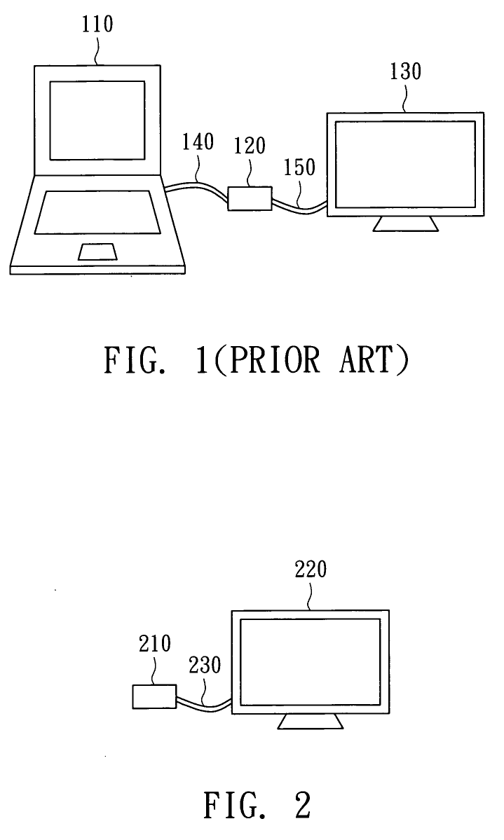

### DETAILED DESCRIPTION OF THE INVENTION

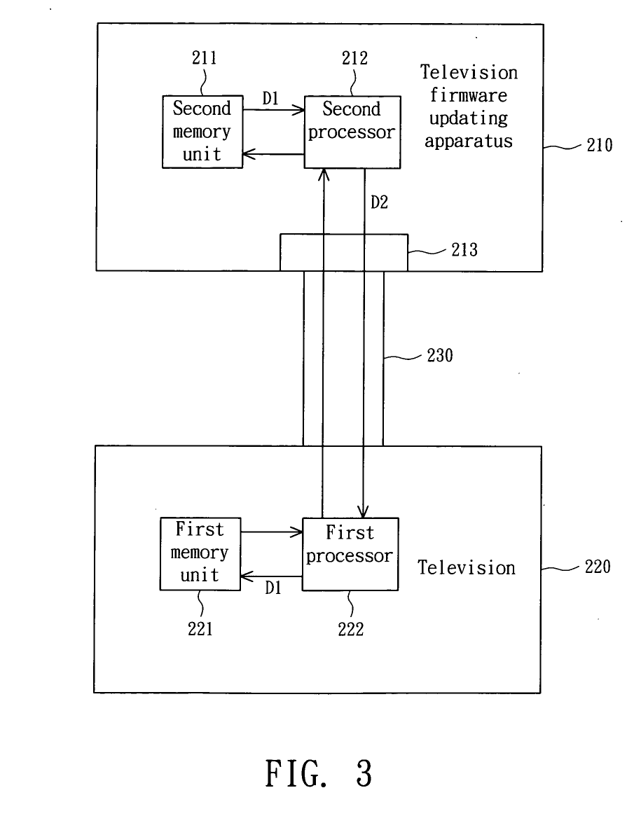

Referring to FIG. 2, a diagram illustrating a television firmware updating apparatus according to a preferred embodiment of the invention being linked to a television is shown. The television firmware updating apparatus 210 is electrically connected to a television 220 via a transmission line 230 for updating a firmware of the television 220. Referring to FIG. 3, a block diagram illustrating the television firmware updating apparatus according to the preferred embodiment of the invention and the television is shown. The television 220 includes a first processor 222 and a first memory unit 221. The first processor 222 is for operating the television 220. The first memory unit 221 is electrically connected to the first processor 222 for storing the firmware for operating the television 220.

The updating firmware apparatus 210 includes a second memory unit 211, a second processor 212 and an output port 213. The second processor 212 is electrically connected to the second memory unit 211 and the output port 213, respectively. The second memory unit 211 stores a firmware for updating the television 220. The updating firmware has a number of block data. The output port 213 is electrically connected to the transmission line 230 for enabling the second processor 212 to be electrically connected to the first processor 222 via the output port 213 and the transmission line 230 and handshake with the first processor 222.

After the second processor 212 handshakes with the first processor 222, the second processor 212 reads a chosen block data D1 stored in the updating firmware of the second memory unit 211 and encodes the chosen block data D1 to an encoded signal D2. Then, the second processor 212 outputs the encoded signal D2 to the first processor 222 via the output port 213 and the transmission line 230.

After the first processor 222 receives the encoded signal D2, the first processor 222 decodes the encoded signal D2 to generate the chosen block data D1 and write the chosen block data D1 to the first memory unit 221 until all the block data of the updating firmware are written to the first memory unit 221. Examples of the second memory unit 211 and the first memory unit 221 include a flash memory. The specification of the output port 213 is RS232 for example. The specification of the encoded signal D2 complies with the specification of RGB signal for example. In the present embodiment of the invention, the television firmware updating apparatus 210 uses a signal pin of the RS232 output port 213 to transmit an encoded signal D2 such as an RGB signal.

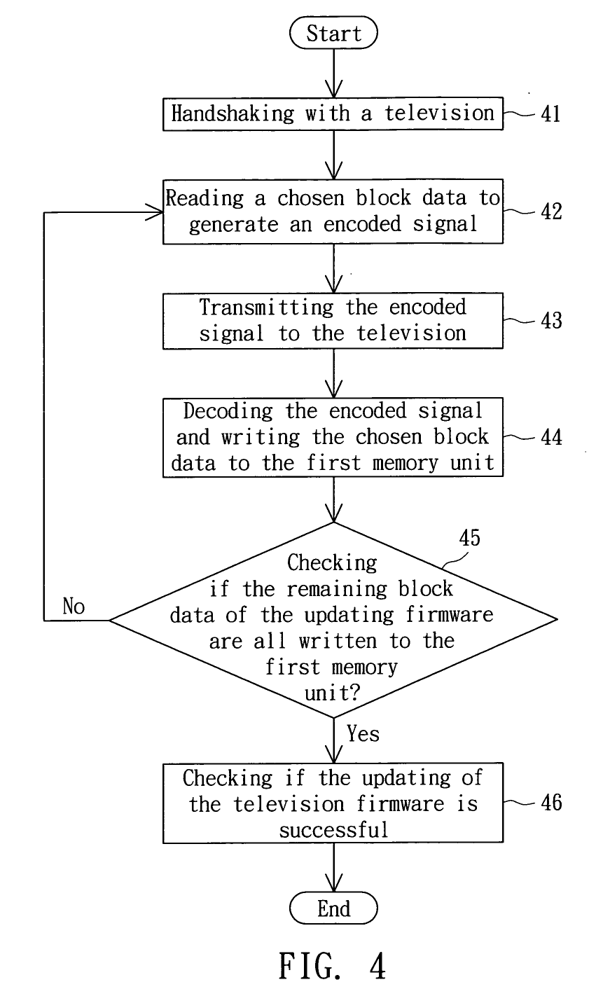

Referring to FIG. 4, a flowchart of a television firmware updating method according to a preferred embodiment of the invention is shown. Firstly, the television firmware updating apparatus 210 handshakes with the television 220 as shown in step 41. Next, the television firmware updating apparatus 210 reads a chosen block data D1 and encodes the chosen block data D1 to generate an encoded signal D2 as shown in step 42. The television firmware updating apparatus 210 transmits the encoded signal D2 to the first processor 222 of the television 220 as shown in step 43. The first processor 222 receives and decodes the encoded signal D2 to generate the chosen block data D1 and write the chosen block data D1 to the first memory unit 221 as shown in step 44. Then, the first processor 222 checks if the remaining block data of the updating firmware are all written to the first memory unit 221 as shown in step 45. If not, steps 42, 43 and 44 are repeated until all the block data of the updating firmware are written to the first memory unit 221. If so, step 46 is processed. Lastly, the second processor 212 handshakes with the first processor 222 again to check if the updating of the television firmware is successful and displays a checking message as shown in step 46.

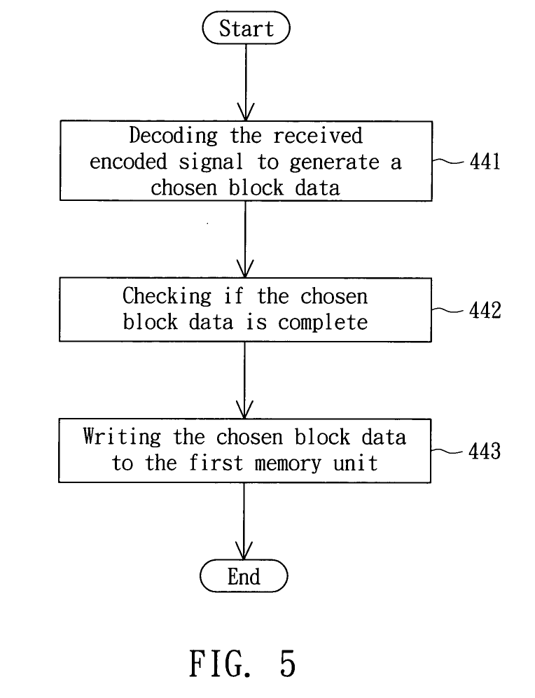

Referring to FIG. 5, the detailed processes of step 44 are shown. Firstly, the first processor 222 decodes the received encoded signal D2 to generate the chosen block data D1 as shown in step 441. Next, the first processor 222 checks if the chosen block data D1 is intact according to the checksum method as shown in step 442. Then, the first processor 222 writes the chosen block data D1 to the first memory unit 221 as shown in step 443. The checking result of step 442 is for the second processor 212 to check if the updating of firmware in step 46 is completed.

In step 46, the second processor 212 of the television firmware updating apparatus 210 checks if the updating firmware is completely written to the first memory unit 221 according to the checking result of step 44. Then, the television firmware updating apparatus 210 uses an indicator module (not shown in the diagram) to display a checking message. For example, if the updating firmware of the television 220 is successfully updated, the indicator module, such as LED, displays a green light. If the updating is failed, a red light is displayed. However, the ways of displaying the message are not limited thereto. In the present embodiment of the invention, when the television 220 needs to update the firmware to a newer version, only the second memory unit 211 having a firmware of newer version needs to be updated. There is no need to update the entire television firmware updating apparatus 210. The television firmware updating apparatus 210 can be powered by battery. When the battery is low, the user is automatically reminded to replace the battery.

The firmware updating apparatus disclosed in the above embodiment of the invention uses fewer components than the prior art would do, hence reducing the component costs. Meanwhile, human interferences during the setting of terminal routines are reduced and so is the failure rate in updating a firmware. The manufacturers and retailers would find the labor and costs for updating the firmware of a large amount of television sets largely decreased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A television firmware updating apparatus for updating a firmware of a television, wherein the television comprises a first processor and a first memory unit, the first memory unit is for storing the television operating firmware, and the television firmware updating apparatus comprises:
a second memory unit for storing an updating firmware of the television, wherein the updating firmware has a plurality of block data; and
a second processor electrically connected to the second memory unit, wherein after the second processor handshakes with the first processor, the second processor reads a chosen block data of the updating firmware and encodes the chosen block data to output an encoded signal;
wherein the first processor receives and decodes the encoded signal to generate the chosen block data and write the chosen block data to the first memory unit until all the block data of the updating firmware are written to the first memory unit.

2. The television firmware updating apparatus according to claim 1, further comprising an output port, wherein the second processor outputs the encoded signal to the first processor via the output port.

3. The television firmware updating apparatus according to claim 2, wherein the specification of the output port is RS232.

4. The television firmware updating apparatus according to claim 1, wherein the encoded signal complies with the specification of RGB signal.

5. The television firmware updating apparatus according to claim 1, wherein after all the block data of the updating firmware are written to the first memory unit, the second processor checks if the television firmware is successfully updated and displays a checking message.

6. The television firmware updating apparatus according to claim 1, wherein the first memory unit is a flash memory.

7. The television firmware updating apparatus according to claim 1, wherein the second memory unit is a flash memory.

8. The television firmware updating apparatus according to claim 1, wherein after the first processor receives and decodes the encoded signal to generate the chosen block data, the chosen block data is checked if the chosen block is intact.

9. A television firmware updating method for a television firmware updating apparatus, wherein the television firmware updating apparatus comprises an updating firmware having a plurality of block data, the method comprises:
(a) handshaking the television firmware updating apparatus with a television, wherein the television comprises a first processor and a first memory unit, and the first memory unit is for storing the television operating firmware;
(b) reading and encoding a chosen block data of the updating firmware to generate an encoded signal;
(c) transmitting the encoded signal to the first processor of the television;
(d) receiving and decoding the encoded signal by the first processor to generate and write the chosen block data to the first memory unit; and
(e) repeating the above steps of (b), (c) and (d) until all the block data of the updating firmware are written to the first memory unit.

10. The television firmware updating method according to claim 9, wherein the encoded signal complies with the specification of RGB signal.

11. The television firmware updating method according to claim 9, wherein the first memory unit is a flash memory.

12. The television firmware updating method according to claim 9, wherein step (d) comprises the following sub-steps:
decoding the encoded signal to generate the chosen block data;
checking if the chosen block data is intact; and
writing the chosen block data to the first memory unit.

13. The television firmware updating method according to claim 9, further comprising a checking step of using the television firmware updating apparatus to check if the updating of the television firmware is successful and display a checking message after all the block data of the updating firmware are written to the first memory unit.
